(19) United States
(12) Patent Application Publication
(10) Pub. No.: US 2010/0297524 A1
(43) Pub. Date: Nov. 25, 2010

(54) MEMBRANE ELECTRODE ASSEMBLY FOR POLYMER ELECTROLYTE FUEL CELL

(75) Inventors: Atsushi KAMACHI, Wako-shi (JP); Yoichi ASANO, Wako-shi (JP); Mihoko KAWAHARADA, Wako-shi (JP)

Correspondence Address: ARENT FOX LLP, 1050 CONNECTICUT AVENUE, N.W., SUITE 400, WASHINGTON, DC, 20036, US

(73) Assignee: HONDA MOTOR CO., LTD., Tokyo (JP)

(21) Appl. No.: 12/783,295

(22) Filed: May 19, 2010

(30) Foreign Application Priority Data
May 21, 2009 (JP) JP2009-123084

(51) Int. Cl. H01M 8/10

(52) U.S. Cl. 429/483

(57) ABSTRACT

A membrane electrode assembly for a polymer electrolyte fuel cell has a polymer electrolyte membrane, a catalytic layer and a diffusion layer of anode formed on one side of the membrane, a catalytic layer and a diffusion layer of cathode formed on the other side of the membrane, in which the cathode catalytic layer includes at least proton conductive material and platinum/platinum alloy powder not containing supporting carbon, the cathode diffusion layer comprises carbon base material, a cathode dividing layer is arranged at a position contacting with the catalytic layer between the catalytic layer and the diffusion layer of cathode side, the cathode dividing layer contains at least electron conductive material, the electron conductive material is one of metallic oxide or graphitized carbon of which index of graphitization degree R value (ratio of peak intensities of G band and D band I_{D}/I_{G} measured by Raman spectroscopy) is less than 1.18.

### BACKGROUND OF THE INVENTION

1. Technical Field

The present invention relates to membrane electrode assemblies for polymer electrolyte fuel cells, and in particular, the present invention relates to a technique for controlling corrosion of a cathode catalytic layer and a diffusion layer by high voltages generated when a fuel cell is shut down.

2. Background Art

Recently, depletion of petroleum resources is a crucial issue, and environmental problems such as air pollution and global warming caused by consumption of fossil fuels have become serious. Under these circumstances, fuel cells have attracted much attention as a clean power source for electric motors in which carbon dioxide is not generated, and such fuel cells are being widely developed and used.

In the case in which such a fuel cell is used in a vehicle, a polymer electrolyte fuel cell in which a polymer electrolyte membrane is used is desirably used since high voltage and large current can be obtained. A membrane electrode assembly for the polymer electrolyte fuel cell is produced as follows: a catalyst such as platinum is carried by a catalyst carrier such as carbon black; a pair of catalytic layers is formed by unifying the catalyst and an ion conducting polymer binder; a polymer electrolyte membrane having ion conductivity is disposed between the catalytic layers; and a gas-diffusion layer is formed on each of the catalytic layers. Furthermore, a separator, which also functions as a gas passage, is formed on each of the gas-diffusion layers to yield a polymer electrolyte fuel cell.

In such a polymer electrolyte fuel cell, a reducing gas, such as hydrogen or methanol, is introduced at one catalytic layer (fuel electrode) through the gas-diffusion layer of the fuel electrode side, and an oxidizing gas such as air or oxygen is introduced at the other catalytic layer (oxygen electrode) through the gas-diffusion layer of the oxygen electrode side.

In the fuel electrode, due to the presence of the catalyst in the catalytic layer, protons and electrons are generated from the reducing gas (H₂→2H⁺+2e⁻) and the protons migrate to the catalytic layer of the oxygen electrode side through the polymer electrolyte membrane. In the oxygen electrode, due to the existence of the catalyst in the oxygen electrode, protons react with the oxidizing gas introduced at the oxygen electrode and electrons to produce water (O₂+4H⁺+4e⁻→2H₂O). Therefore, by electrically connecting the fuel electrode and the oxygen electrode with a lead, a circuit in which electrons generated in the fuel electrode migrate to the oxygen electrode is formed, and electric current is obtained.

Generally, under conditions in which the fuel cell is shut down and the load is cut off, that is, during the shutdown conditions of the fuel cell, air is fed into the anode electrode to purge hydrogen. However, the hydrogen is not completely removed and some still remains there, and both hydrogen and air are present at the anode. Under such conditions, the hydrogen is ionized to produce protons and electrons. Although the protons migrate to the cathode side through the polymer electrolyte membrane, the electrons react with the air that is present at the anode since the circuit is cut off.

In the case in which such a reaction is promoted, the voltage of the cathode is increased, electrochemical oxidation reactions of carbon in the cathode catalytic layer occur, that is, the carbon part of the platinum catalyst supporting the carbon is corroded and extinguished, and as a result, fine platinum particles drop off the supporting carbon. Since the fine platinum particles that drop off aggregate to reduce surface area, the catalytic action is lost, and as a result, the performance of the fuel cell is deteriorated in all the ranges of current. In addition, because of the corrosion of the supporting carbon, hydrophilicity of the supporting carbon is increased and the structure of the electrode is crushed. Therefore, in particular, flooding may easily occur in high ranges of current, and the performance of the fuel cell is greatly deteriorated, and thus problems of durability may occur.

To solve such problems relating to corrosion of the carbon, a technique in which fine platinum particles (platinum black or the like) are singly dispersed in catalytic layer, not using supporting carbon which is easily corroded, has been disclosed (see Japanese Unexamined Patent Application Publication No. 2006-185855). In this technique, since the platinum catalyst does not originally have supporting carbon, deterioration of catalytic action by carbon corrosion can be prevented even in situations of high voltages of cathodes during the above-described shutdown conditions.

Although deterioration of catalytic action of platinum catalysts can be controlled by using platinum catalysts not having supporting carbon, since carbon particles are contained in a diffusion layer or an intermediate layer in an actual electrode, a part in which the platinum particles of the catalytic layer and the carbon particles of the diffusion layer contact each other becomes a starting point, and then the carbon particles of the diffusion layer may be easily corroded from the starting point. By this phenomenon, flooding may easily occur at an interface of the diffusion layer or the intermediate layer and the catalytic layer, performance at high ranges of current is greatly deteriorated, and durability, which the platinum black inherently has, cannot be exhibited sufficiently.

### SUMMARY OF THE INVENTION

The present invention was completed in view of the above-mentioned circumstances, and an object of the invention is to provide a membrane electrode assembly for a polymer electrolyte fuel cell which can control corrosion of carbon at the cathode side even under conditions of high voltage at the cathode during shutdown of the fuel cell, to control the deterioration of performance of the fuel cell for long periods.

The membrane electrode assembly, for polymer electrolyte fuel cells, of the present invention, in a first aspect, includes an anode catalytic layer and an anode diffusion layer stacked on one surface of a polymer electrolyte membrane, in this order, and a cathode catalytic layer and a cathode diffusion layer stacked on the other surface of the polymer electrolyte membrane, in this order. The cathode catalytic layer includes at least a proton conductive material and a platinum powder or a platinum alloy powder not having a supporting carbon. The cathode diffusion layer includes a carbon base material. A cathode dividing layer containing at least an electron conductive material is arranged at a location at which the cathode catalytic layer contacts between the cathode catalytic layer and the cathode diffusion layer. In this aspect, the electron conductive material is a graphitized carbon of which the index of graphitization degree R value of the carbon is less than 1.18.

Furthermore, the membrane electrode assembly, for polymer electrolyte fuel cells, of the present invention, in a second aspect, includes an anode catalytic layer and an anode diffusion layer stacked on one surface of a polymer electrolyte membrane, in this order, and a cathode catalytic layer and a cathode diffusion layer stacked on the other surface of the polymer, electrolyte membrane, in this order. The cathode catalytic layer includes at least a proton conductive material and a platinum powder or a platinum alloy powder not having a supporting carbon. The cathode diffusion layer includes a carbon base material. A cathode dividing layer containing at least an electron conductive material is arranged at a position at which the cathode catalytic layer contacts between the cathode catalytic layer and the cathode diffusion layer. In this aspect, the electron conductive material is a metallic oxide.

According to the first aspect of the present invention, since carbon particles having low R values, that is, a high index of graphitization degree, is used as the cathode dividing layer which divides the cathode catalytic layer and the cathode diffusion layer, corrosion of the carbon is controlled, and adverse effects on durability of the catalytic layer not having a supporting carbon can be controlled to be minimal. Alternatively, according to the second aspect, since the electron conductive oxide is used instead of the carbon particle, it is not easily corroded even at high voltages, and the performance can be maintained for long periods under the entire range of conditions.

### BRIEF DESCRIPTION OF DRAWINGS

FIG. 1 is a conceptual diagram showing a cross section of the fuel cell of the present invention having a dividing layer.

FIG. 2 is a magnified diagram showing the cathode electrode part of the membrane electrode assembly of an embodiment of the present invention.

FIG. 3 is a magnified diagram showing a cathode electrode part of a conventional electrode assembly.

FIG. 4 is a magnified diagram showing the cathode electrode part of the membrane electrode assembly of another embodiment of the present invention.

FIG. 5 is a graph showing a relationship between number of cycles and cell voltage in the high voltage cycle testing.

FIG. 6 is a graph showing a relationship between R value and voltage retention rate at initial deterioration in the high voltage cycle examination.

FIG. 7 is a graph showing a result of analysis of carbon material by Raman spectroscopy.

### EXPLANATION OF REFERENCE NUMERALS

F: Fuel cell (membrane electrode assembly+separator),
1: Polymer electrolyte membrane,
2: Cathode electrode, 20: Cathode catalytic layer, 21: Cathode dividing layer, 22: Cathode diffusion layer, 23: intermediate layer, 24: Platinum (alloy) powder, 25: Proton conductive material, 26: Carbon material (such as VGCF) having R value, 27: Carbon material (such as carbon black) not having R value, 28: Electron conductive metallic oxide,
3: Anode electrode, 30: Anode catalytic layer, 31: Anode dividing layer, 32: Anode diffusion layer,
4: Cathode separator, 40: Flow passage,
5: Anode separator, 50: Flow passage.

### EMBODIMENTS OF THE INVENTION

Appropriate Embodiments of the present invention are further explained below.

### Common Constituent Elements

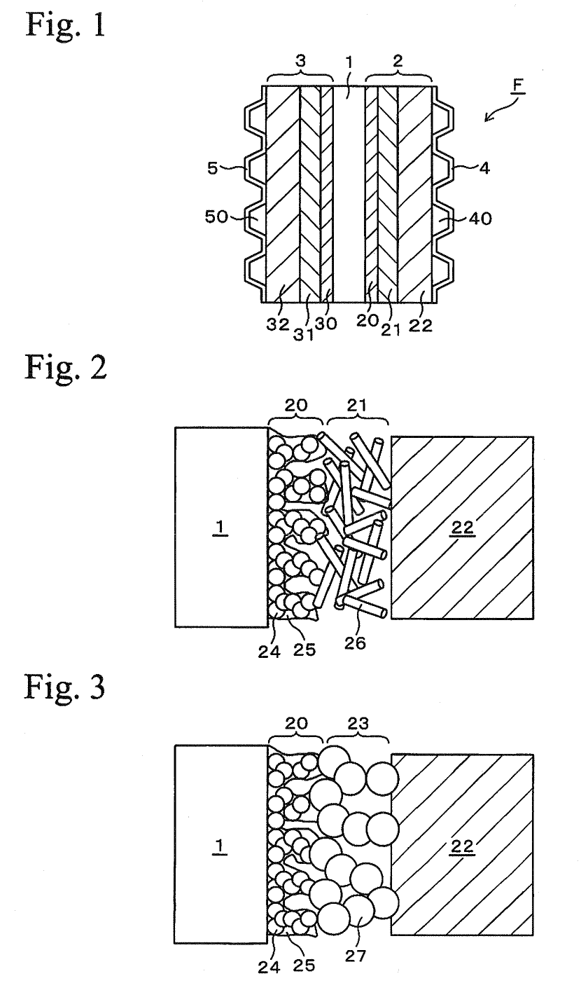

The present invention concerns to a fuel cell in which metallic particles (for example, particles of platinum black) not having supporting carbon are used as a cathode catalyst, and FIG. 1 shows a conceptual diagram of such a polymer electrolyte fuel cell having the membrane electrode assembly of the present invention. The fuel cell F includes a polymer electrolyte membrane 1, a cathode electrode 2 and an anode electrode 3 formed on each side of the membrane, and a cathode separator 4 and an anode separator 5 each formed on a corresponding electrode. Furthermore, the present invention is characterized in that the cathode electrode 2 includes a cathode catalytic layer 20, a cathode diffusion layer 22, and a cathode dividing layer 21 which is explained below.

The cathode dividing layer 21 of the present invention can be formed between the cathode catalytic layer 20 in which metallic particles not having supporting carbon are used as a catalyst, and the conventional cathode diffusion layer 22. Therefore, as the cathode diffusion layer 22, plural diffusion layers each having different functions can be employed, or a complex layer of the diffusion layer and an intermediate layer consisting of a carbon material different from that of the diffusion layer can be employed.

In FIG. 1, the anode electrode 3 also includes three layers, that is, an anode catalytic layer 30, an anode dividing layer 31, and an anode diffusion layer 32; however, the present invention is characterized by a structure in which at least the cathode electrode 2 includes the dividing layer, and therefore, the structure of the anode electrode 3 is not limited in particular, an anode electrode having the dividing layer can be employed, or a conventional anode electrode consisting of two layers (catalytic layer+diffusion layer) not having the dividing layer can be employed.

As the catalytic particle not having supporting carbon used in the cathode catalytic layer 20, platinum is desirable. Alternatively, another metal such as iridium or the like, an alloy of platinum and another metal, or a core shell in which platinum and another metal do not form an alloy can be used. In addition, particles having hollow structures or fiber shapes can be used.

### First Embodiment

FIG. 2 shows an enlarged diagram of the cathode electrode 2 of the first embodiment of the present invention. On the polymer electrolyte membrane 1, the cathode catalytic layer 20, the cathode dividing layer 21, and the cathode diffusion layer 22 are formed, in this order. In the present embodiment, the cathode catalytic layer 20 includes a mixture of platinum powders or platinum allow powders 24 and proton conductive material 25 such as Nafion or the like, and the cathode diffusion layer 22 includes a conventional carbon base material. The cathode catalytic layer 20 and cathode diffusion layer 22 are divided by the cathode dividing layer 21. Furthermore, as the electron conductive material forming the cathode dividing layer 21, a graphitized carbon having an index of graphitization degree R value of less than 1.18 is used.

Hereinafter the R value is explained. FIG. 7 is a graph showing a result of analysis of the carbon sample by Raman spectroscopy. Raman spectroscopy is a method to analyze the structure of a sample by analyzing Raman scattering light. In the case in which a carbon material is analyzed by Raman spectroscopy, as shown in FIG. 7, two peaks are usually observed around 1360 cm⁻¹ and 1580 cm⁻¹. Graphite having high crystallinity has a single peak around 1580 cm⁻¹, and the peak is usually called the G band. On the other hand, in the case in which crystallinity is decreased (defects in crystal structure are common), the peak, usually called the D band, occurs around 1360 cm⁻¹. Therefore, the R value which is the ratio of intensity of the D band and the G band (I_{D}/I_{G}) can be an index of graphitization degree of the carbon material, and it can be said that the graphitization degree is high as the R value is low.

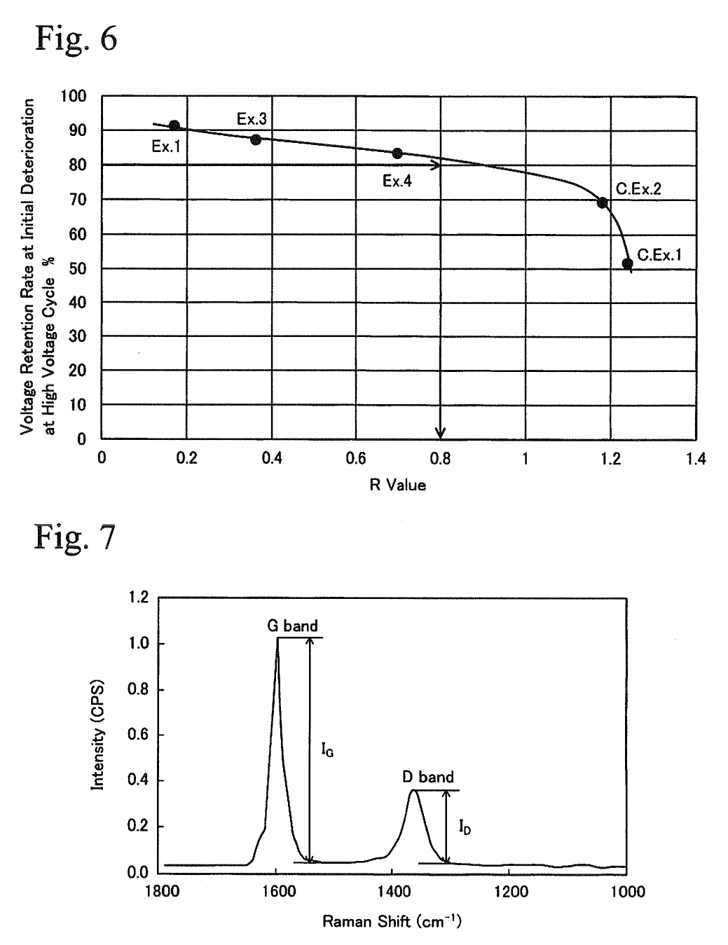

In the present invention, as is shown in Examples below, as a result of performing research on carbon materials each having different R values, it was discovered that the voltage retention rate at high voltage is high if the R value is less than 1.18, that is, corrosion of carbon is controlled, as shown in the graph of FIG. 6. As a carbon material 26 that satisfies the necessary R value, VGCF (vapor growth carbon fiber), graphitized Ketjenblack, acetylene black or the like is desirable.

It is more desirable that the R value be not more than 1.1, and it is even more desirable that the R value be not more than 0.8 since the voltage retention rate is not less than 80% (initial deterioration is less than 20%). On the other hand, in the case in which the R value does not meet the range of the present invention, the graphitization degree is not sufficient, and it may be deteriorated under high voltage, and the function as the dividing layer cannot be obtained. The shape of such carbon material 26 is not particularly limited, and a freely selected shape such as grains or fibers can be employed.

### Second Embodiment

The second embodiment of the present invention is characterized in that metallic oxide particles having electrical conductivity are used as the electron conductive material forming the cathode dividing layer 21. In the case in which platinum particles not having supporting carbon are used as the cathode catalyst, as mentioned above, since another carbon material which contacts the platinum particle is corroded, the R value of the carbon material must be considered; however, since the metallic oxide particle is used in the second embodiment instead of the graphitized carbon of the first embodiment, there is no carbon to be corroded.

As such a metallic oxide particle, materials having electric conductivity and corrosion resistance, for example, Nd doped TiO₂, Ti₄O₇, SnO₂ or the like are desirably used. The shape of such electric conductive metallic oxide particles is not particularly limited, and freely selected shapes such as grains or fibers can be employed.

### EXAMPLES

The present invention is further explained by way of Examples and Comparative Examples.

### A. Preparation of Membrane Electrode Assembly

### Example 1

The membrane electrode assembly of Example 1 was prepared as follows. The structure corresponds to the conceptual diagram of FIG. 2.
Polymer electrolyte membrane: Nafion112 (thickness: 50 μm)
Anode catalytic layer: 50% platinum supporting carbon (amount of platinum supported: 0.4 mg/cm², average diameter of platinum particle: 2 nm, carbon black: Vulcan XC72)
Anode diffusion layer: carbon paper produced by Toray
Cathode catalytic layer: formed by a mixture of platinum black having average particle diameter of 7 nm (without supporting carbon) and Nafion (amount of platinum supported: 0.9 mg/cm²)
Cathode divided layer: formed by a mixture of VGCF produced by SHOWA DENKO (R value=0.17, carbon nanofiber having high crystallinity synthesized by a vapor phase method) and PTFE (functioning as binder and water repellant)
Cathode diffusion layer: carbon paper produced by Toray

### Comparative Example 1

The membrane electrode assembly of Comparative Example 1 was prepared in a manner similar to that of Example 1, except that a cathode intermediate layer formed by a mixture of Ketjenblack EC (R value=1.24) and PTFE was arranged instead of the cathode dividing layer of Example 1. The structure corresponds to the conceptual diagram of FIG. 3.

### Comparative Example 2

The membrane electrode assembly of Comparative Example 2 was prepared in a manner similar to that of Comparative Example 1, except that Vulcan XC72 (R value=1.18) was used instead of Ketjenblack EC (R value=1.24) of Comparative Example 1. The structure corresponds to the conceptual diagram of FIG. 3.

### Example 2

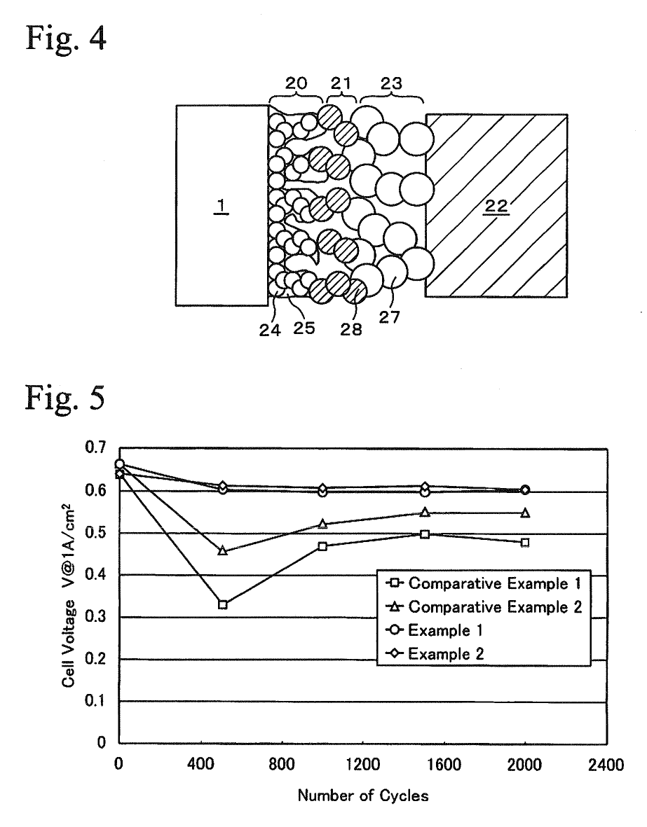

The membrane electrode assembly of Example 2 was prepared in a manner similar to that of Example 1, except that the cathode dividing layer was formed by electron conductive oxide Ti₄O₇ instead of VGCF (R value=0.17) of Example 1 and further except that a cathode intermediate layer formed by a mixture of Vulcan XC72 and PTFE was arranged between the cathode dividing layer and the cathode diffusion layer. The structure corresponds to the conceptual diagram of FIG. 4.

### Example 3

The membrane electrode assembly of Example 3 was prepared in a manner similar to that of Example 1, except that the cathode dividing layer was formed by graphitized Ketjenblack produced by LION (R value=0.36) instead of VGCF (R value=0.17) of Example 1. The structure corresponds to the conceptual diagram of FIG. 2.

### Example 4

The membrane electrode assembly of Example 4 was prepared in a manner similar to that of Example 1, except that the cathode dividing layer was formed by acetylene black produced by SHOWA DENKO (R value=0.7) instead of VGCF (R value=0.17) of Example 1. The structure corresponds to the conceptual diagram of FIG. 2.

### B. High Voltage Cycle Testing

A separator was arranged on both diffusion layers of each of the membrane electrode assemblies of Examples 1 and 2 and Comparative Examples 1 and 2, to form fuel cells of the Examples and the Comparative Examples. Supplying hydrogen and air from the anode and the cathode respectively to start operation of a cell at a cell temperature of 80°, 100% RH relative humidity, and at atmospheric pressure, the high voltage cycle testing was performed by repeating a cycle process, each cycle process consisting of applying a voltage of 1.3 V for 10 seconds and 0.8 V for 30 seconds.

The graph of FIG. 5 shows the results of the testing. As is shown in FIG. 5, an initial deterioration in which performance first deteriorated at the beginning (during about 500 cycles) and then recovered and plateaued, was observed to be serious in Comparative Examples 1 and 2; however, the initial deterioration was controlled in Examples 1 and 2. Furthermore, performance gradually deteriorated after the initial deterioration in Comparative Examples 1 and 2; however, performance plateaued and maintained for a long period in Examples 1 and 2.

### C. R Value and Voltage Retention Rate

FIG. 6 is a graph showing the relationship between voltage retention rate at the initial deterioration in the high voltage cycle examination and R value of the carbon material used in the dividing layer in Examples 1, 3, and 4 and Comparative Examples 1 and 2. As is shown in FIG. 6, the voltage retention rate is radically reduced in the range of an R value not less than 1.18; however, the voltage retention rate can be maintained at not less than 70% in the range of an R value less than 1.18. It should be noted that data of Example 2 is not shown in the graph since metallic oxide is used instead of the carbon material in Example 2 and therefore the R value cannot be defined.

In the present invention, a fuel cell in which performance deterioration is controlled even under high voltage conditions that occur at the shutdown of the fuel cell can be provided.

What is claimed is:

1. A membrane electrode assembly for a polymer electrolyte fuel cell comprising:
a polymer electrolyte membrane;
an anode catalytic layer formed on one side of the polymer electrolyte membrane;
an anode diffusion layer formed on the anode catalytic layer;
a cathode catalytic layer formed on the other side of the polymer electrolyte membrane; and
a cathode diffusion layer formed on the cathode catalytic layer;
wherein the cathode catalytic layer includes at least a proton conductive material and a platinum powder or a platinum alloy powder not containing a supporting carbon,
the cathode diffusion layer comprises a carbon base material,
a cathode dividing layer is arranged at a position contacting the cathode catalytic layer between the cathode catalytic layer and the cathode diffusion layer,
the cathode dividing layer contains at least an electron conductive material, and
the electron conductive material is graphitized carbon in which the index of graphitization degree R value, which is the ratio of the peak intensity of the G band I_{G} appearing around 1580 cm⁻¹ and the peak intensity of the D band I_{D} appearing around 1360 cm⁻¹ when the carbon is measured by Raman spectroscopy, I_{D}/I_{G} is less than 1.18.

2. A membrane electrode assembly for a polymer electrolyte fuel cell comprising:
a polymer electrolyte membrane;
an anode catalytic layer formed on one side of the polymer electrolyte membrane;
an anode diffusion layer formed on the anode catalytic layer;
a cathode catalytic layer formed on the other side of the polymer electrolyte membrane; and
a cathode diffusion layer formed on the cathode catalytic layer;
wherein the cathode catalytic layer includes at least a proton conductive material and a platinum powder or a platinum alloy powder not containing a supporting carbon,
the cathode diffusion layer comprises a carbon base material,
a cathode dividing layer is arranged at a position contacting the cathode catalytic layer between the cathode catalytic layer and the cathode diffusion layer,
the cathode dividing layer contains at least an electron conductive material, and
the electron conductive material is a metal oxide.
